(19) United States
(12) Patent Application Publication
(10) Pub. No.: US 2008/0162664 A1
(43) Pub. Date: Jul. 3, 2008

(54) TECHNIQUE FOR THROTTLING A WEB SERVICE DYNAMICALLY

(76) Inventor: Harshavardhan Jegadeesan, Tamil Nadu (IN)

Correspondence Address: SAP AG, 3410 HILLVIEW AVENUE, PALO ALTO, CA, 94304, US

(21) Appl. No.: 11/617,721

(22) Filed: Dec. 29, 2006

(51) Int. Cl. G06F 15/16; G06F 15/173; G06F 9/445; G06F 9/46

(52) U.S. Cl. 709/217; 709/223; 718/105; 719/328

(57) ABSTRACT

A method for generating a scrip dynamically for a server hosting a web service in a communication network. The properties of the scrip are determined dynamically and issued to a client requesting access to the web service. The scrip allows throttling the web service dynamically. The scrip also allows balancing a load on a group of servers hosting the web service.

### FIELD OF THE INVENTION

The invention relates to the field of administering a web service hosted on a server in a communication network.

### BACKGROUND OF THE INVENTION

A web service is typically an application running on a server that provides services that include shopping service, music downloading service, and image downloading service. These services may be accessed over a communication network. When the number of requests for the service goes beyond a certain limit, for example, serving capacity of the server, the server may refuse the requests or delay the response to already accepted requests. Thus, the efficiency and quality of service may go down. One solution to this problem may be to limit the number of requests to the service on the server.

Throttling is a mechanism used to limit the number of requests to the web service either by refusing or delaying requests in a specified time interval to provide better quality of service. A few examples of throttling policy include concurrent, idle, request and volume. Concurrent throttle policy imposes a limit on the number of concurrent requests at any one time. Idle throttle policy imposes a minimum idle time between requests. Request throttle policy imposes a limit on the number of requests per period. Volume throttle policy imposes a limit on the volume such as kilobytes sent per period. But these throttling policies are static in nature, that is, once the policy is configured and enforced on the web service the policies do not change according to the behavior of the network. Consider a scenario where in the request throttle policy configured as one request per minute is enforced on the web service. Now, the web service obtains a first request and serves the first request in thirty seconds. The web service is now typically idle for another thirty seconds since it is configured to take the next request only after a minute from taking the previous request. Thus, this throttling policy may be inefficient as the idle time of the web service is not used.

The quality of service of the web service may also be improved by typically hosting the web service on more than one server. But, once the number of servers is increased, a mechanism to balance the load between the servers may be necessary. The load balancing technologies are typically based on a central server that determines the load on servers hosting the web service and distributes the requests among the servers accordingly. Such load balancing technologies typically have the disadvantage of having a single point of failure. If, the central server determining and balancing the load fails, the web service may not be accessible anymore. Moreover, throttling mechanisms typically get more complicated as the number of servers hosting the web service increase.

### SUMMARY OF THE INVENTION

What is described is a system and method for generating a scrip dynamically for a server hosting a web service in a communication network. The properties of the scrip are determined dynamically and issued to a client requesting access to the web service. An embodiment involves throttling the web service dynamically based on the scrip. The scrip also allows balancing a load on a group of servers hosting the web service.

### BRIEF DESCRIPTION OF THE DRAWINGS

FIG. 1 is a block diagram of the properties of a scrip according to an embodiment of the invention.

FIG. 2 is a block diagram of a system for generating the scrip according to an embodiment of the invention.

FIG. 3 is a flow diagram for generating the scrip according to an embodiment of the invention.

FIG. 4 is a flow diagram of the FIG. 3 for generating the scrip according to an embodiment of the invention.

FIG. 5 is a flow diagram for determining the properties of the scrip according to an embodiment of the invention.

FIG. 6 is a flow diagram for updating the properties of the scrip according to an embodiment of the invention.

FIG. 7 is a block diagram of a system for updating the properties of the scrip according to an embodiment of the invention.

FIG. 8 is a block diagram of a system for allocating the scrip to a client requesting the web service according to an embodiment of the invention.

FIG. 9 is a block diagram of a system for communication between various servers in a communication network hosting the web service according to an embodiment of the invention.

### DETAILED DESCRIPTION

Throttling is a mechanism typically used to limit the number of requests to a web service either by refusing or delaying requests in a specified time interval to provide better quality of service. An embodiment illustrates throttling the web service hosted on a server in a communication network by generating a scrip.

In one embodiment, the scrip is generated based on quantum of the server hosting the web service. The scrip is typically like a currency that has a value and may be used by a client to access the web service. The quantum is typically the capacity of the server to serve a request from the client. The quantum is calculated based on the factors that include processing power of the server, current rate of service of the server, future projection on the number of requests, geographical location of the server and time of the day. The quantum is used to calculate scrip value of the server and the scrip value is split into one or more denominations and issued to the client requesting access to the web service. The client may access the web service only if the client possesses the scrip. In this way, the number of requests to the web service may be limited by issuing the scrip to the client in a controlled manner. The scrip also allows balancing the load between one or more servers hosting the web service.

FIG. 1 is a block diagram of the properties of a scrip 140 according to an embodiment of the invention. The scrip 140 typically has properties that include attributes like server address 100, denomination 110, last access time 120 of the web service by the client and scrip value 130. The scrip 140 is typically generated dynamically and the properties may be determined dynamically.

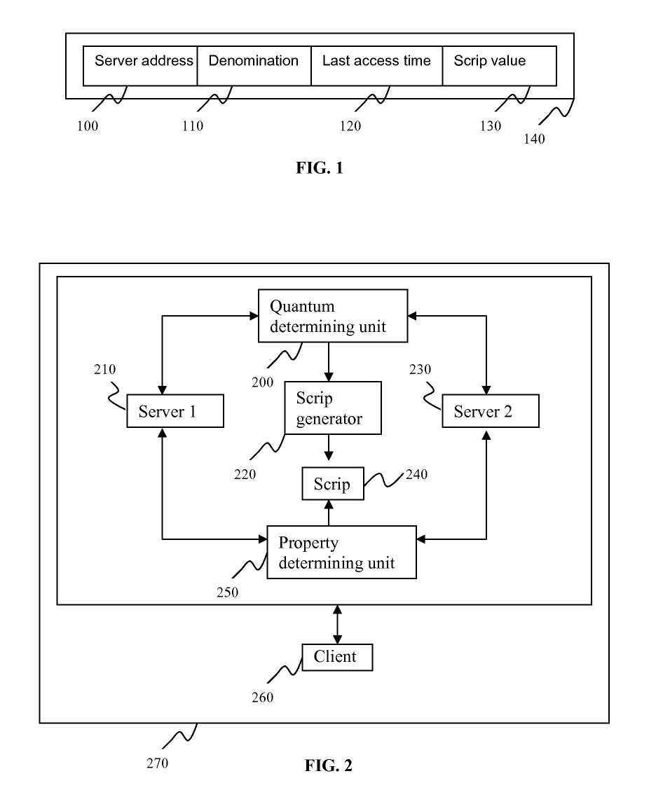

FIG. 2 is a block diagram of a system 270 for generating a scrip 240 according to an embodiment of the invention. The scrip generator 220 generates the scrip 240 for a first server 210 hosting the web service in the communication network. The scrip generator 220 generates the scrip 240 based on quantum of the first server 210. The quantum determining unit 200 determines the quanta of the first server 210 and a second server 230 hosting the web service in the communication network. After determining the quanta of the first server 210 and the second server 230, scrip value of the first server 210 is determined. The scrip value of the first server 210 may be split into various denominations and may be distributed among the first server and the second server for issuing the scrip to the client 260. Properties determining unit 250 determines the properties of the scrip 240 before issuing the scrip 240 to the client 260. The client 260 may then access the web service hosted on the first server 210 whose address is specified in the scrip 240.

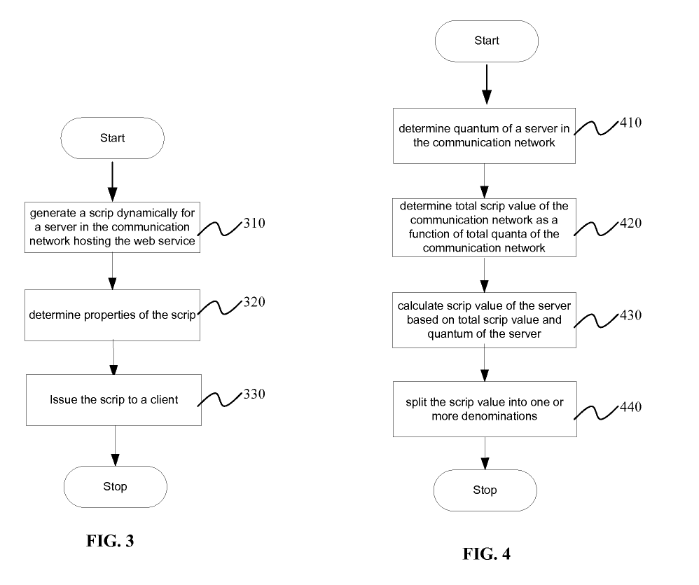

FIG. 3 is a flow diagram for generating the scrip according to an embodiment of the invention. Step 310 illustrates generating the scrip for a server hosting the web service. Step 320 illustrates determining the properties of the scrip. The scrip may be issued to a client requesting the web service as depicted at 330.

FIG. 4 is a flow diagram of the FIG. 3 for generating the scrip for a first server hosting the web service according to an embodiment of the invention. Step 410 illustrates determining a quantum of the first server. The quantum of the first server is typically determined as a function (Fn) of the factors that include processing power (PP) of the first server, current rate of service (CRS) of the first server, future projection (FP) on the number of requests, geographical location (GL) of the first server and time (T) of the day.

The quantum of the first server is typically represented by the formula Q=Fn(PP (t), CRS (t), FP (t), GL (t), T) where Q is quantum of the first server and (t) is a time interval at which the quantum is determined. In an embodiment, the formula is a first order equation.

The first server typically communicates to a second server hosting the web service, for example, about the quantum of the first server over multicast internet protocol (IP). A total quanta of the communication network, that is, the sum total of the quantum of the first server and the second server are determined. The total quanta may be calculated using the formula, TQ=Q1+Q2 where TQ is the total quanta of the communication network including the first server and the second server, Q1 is the quantum of the first server and Q2 is the quantum of the second server. A total scrip value of the communication network is determined as a function of the total quanta as illustrated in step 420. The total scrip value is represented by the formula TSv=Fn(TQ) where TSv is the total scrip value of the communication network. In an embodiment, the formula is a first order equation. The scrip value of the first server may be then determined based on the total scrip value and quantum of the first server as illustrated in step 430. The scrip value of the first server may be calculated using the formula Sv=TSv/Q, where Sv is the scrip value of the first server and Q is the quantum of the first server. The scrip value of the first server may be split into one or more denominations as illustrated in step 440 which may be later issued to the client. For example, if the scrip value of the first server is 50, the scrip may be split into denominations of 5, 5, 10, 15 and 15. The scrip of various denominations may be issued to the client. The process of generating the scrip may be repeated at regular intervals of time. The scrip typically has a specific life time after which the scrip expires. The quantum of the first server may change with respect to time and hence the calculation of the quantum of the first server and the generation of scrip is done at regular intervals of time.

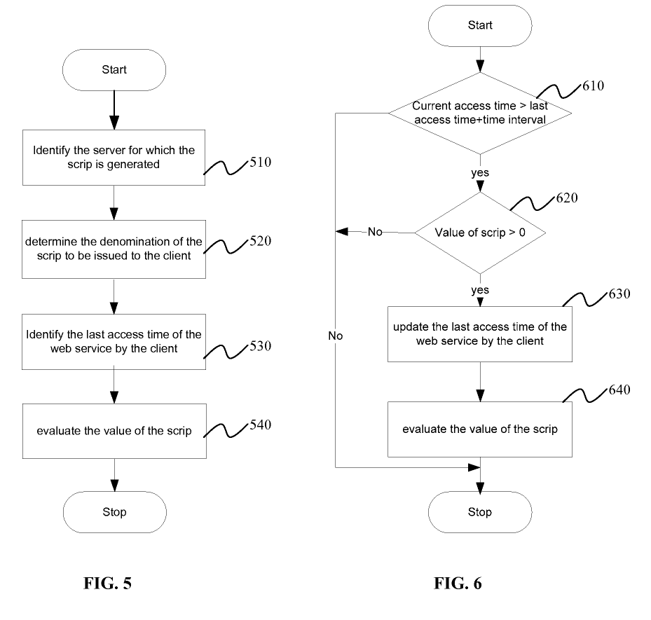

After the scrip has been split into various denominations, the properties of the scrip may be determined. FIG. 5 is a flow diagram for determining the properties of the scrip according to an embodiment of the invention. A server address of a server for which the scrip is generated is identified and may be updated in the scrip as depicted at step 510. A determination is made on the denomination of the scrip to be issued to the client as depicted at step 520. The determination is typically made based on factors that include priority of the client, time of the day, and geography of the client. A premium client may get the scrip with a higher denomination. For example, the employees of a corporation may be issued the scrip that never expires to access the web service hosted by the corporation. Once, the determination is made on the denomination of the scrip to be issued to the client, the last access time of the web service by the client may be updated as depicted at step 530 and the value of the scrip is evaluated as depicted at step 540. In an embodiment the value may be updated with the value of the denomination of the scrip and then the scrip may be issued to the client requesting access to the web service.

FIG. 6 is a flow diagram for updating the properties of the scrip according to an embodiment of the invention. The properties of the scrip are updated on every access to the web service. When a request for the web service is received at a server, at step 610 the server checks if the current request from a client is received after a specified time interval from the last request by the client. If the current request is received after the specified time interval, then a check is made on the value of the scrip as depicted at step 620 else the request to access the web service is rejected. At step 620 a check is made on the value of the scrip. If the value of the scrip is greater than or equal to zero, then access to the web service is granted to the client. The last access time of the web service by the client is updated as depicted in step 630 and the value of the scrip is updated as depicted in step 640. In an embodiment of the invention, the value of the scrip is evaluated by decreasing the value of the scrip by 1 on every access to the web service. In another embodiment, the value of the scrip may not be decreased for premium clients. The premium client may have unlimited access to the web service.

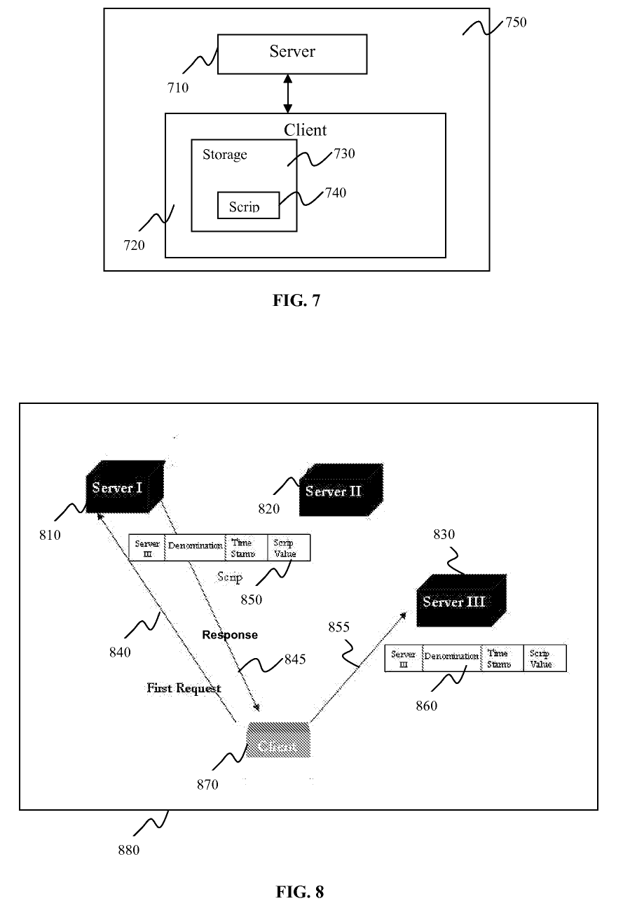

FIG. 7 is a block diagram of a system 750 for updating the properties of a scrip 740 according to an embodiment of the invention. The scrip 740 may be persisted on a client 720, for example, as a cookie in a storage medium 730 and the client 720 may have an application programming interface (API) to update the properties of the scrip 740.

FIG. 8 is a block diagram of a system for allocating the scrip to a client 870 requesting the web service according to an embodiment of the invention. The client 870 requests a first server 810 hosting the web service access to the web service as depicted by 840. The web service is typically hosted on a group of servers that include the first server 810, a second server 820 and a third server 830. The first server 810 identifies the client by a unique client identifier (UCI) which is typically a combination of an IP address of the client 870 and a port number of the client 870 from which the request is made. The first server 810 then sends a response 845 by issuing the scrip 850 to the client 870 after determining the denomination of the scrip 850. The first server 810 may identify a server that is free to serve the request and then issue the scrip 850 of the server to the client 870. The client 870 receives the scrip 850 and the request 855 for the web service is transferred to the third server 830 whose address is specified in the properties of the scrip 860. The whole process of receiving the scrip 850 from the first server 810 and the request being transferred to the third server 830 happens without any user intervention. The client 870 may typically just request the first server 810 access to the web service and the further process involved in accessing the web service on the third server 830 happens automatically, that is, no additional effort may be required from the user for requesting access to the web service hosted on the third server 830.

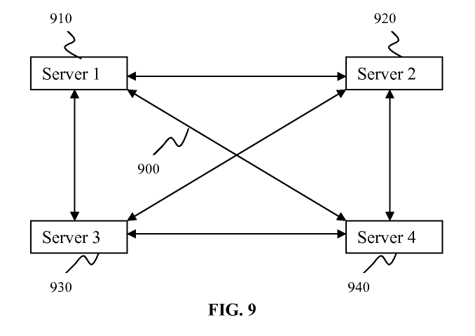

FIG. 9 is a block diagram of a system for communication between various servers in a communication network hosting the web service according to an embodiment of the invention. A group of servers, a first server 910, a second server 920, a third server 930 and a fourth server 940 in a communication network 900 host the web service. The communication within the group of servers is typically via multicast IP. Multicast IP is typically a bandwidth-conserving technology that reduces communication network traffic by simultaneously delivering a single stream of information to one or more recipients. Examples of applications that communicate via multicast IP include videoconferencing, corporate communications, distance learning, and distribution of software, stock quotes, and news. Multicast IP delivers information from a source to one or more recipients without adding any additional burden on the source or the recipients while using the least communication network bandwidth. The recipients that are interested in sharing the information typically form a multicast group. The recipient may be a member of the multicast group to receive the information. In an embodiment, the group of servers, first server 910, the second server 920, the third server 930 and the fourth server 940 form a multicast group.

By issuing the scrip in a controlled manner, throttling may be achieved dynamically. In one embodiment, the scrip may not allow the client to access the web service more than once within a defined time interval and hence prevents the congestion in the communication network within the time interval. The scrip may not allow a group of clients to access the web service hosted on a first server at the same time. The scrip may be issued by the first server to the client in a controlled manner so as to distribute the requests from the group of clients between the first server and a second server hosting the web service. The distribution of requests between the first server and the second server also typically results in reduction of congestion at the first server. As a result, the delay caused in serving the client is typically reduced and hence the quality of service is typically improved. Also, the load between the first server and second server is balanced by issuing the scrip. At any point of time, typically limited number of scrips is generated for the first server and the second server. Also, the scrips are generated based on the quanta of the first server and the second server. Hence, the first server may not be overloaded as the scrip generated for the first server will typically have the value according to the serving capacity of the first server.

What is claimed is:

1. A method, comprising:
generating a scrip dynamically for a first server hosting a web service in a communication network;
determining properties of the scrip dynamically; and
issuing the scrip to a client requesting access to the web service.

2. The method in claim 1, further comprising:
throttling the web service by using the scrip; and
balancing a load between the first server and a second server hosting the web service by using the scrip.

3. The method in claim 1, wherein the properties of the scrip comprises attributes selected from a group consisting of web server address, denomination of the scrip, last access time of the web service and value of the scrip.

4. The method in claim 1, wherein generating a scrip dynamically comprises:
determining a quantum of the first server dynamically;
determining a total scrip value of the communication network comprising the first server and a second server hosting the web service as a function of total quanta of the communication network comprising the first server and the second server;
determining a scrip value of the first server based on the total scrip value of the communication network and quantum of the first server; and
splitting the scrip value into one or more denominations.

5. The method in claim 4, wherein determining the quantum of the first server dynamically comprises determining the quantum based on factors selected from a group consisting of geographical location of the first server, number of clients requesting the web service, processing power of the first server and future projection of a number of requests.

6. The method in claim 1, wherein determining the properties of the scrip dynamically comprises:
identifying a server by address for which the scrip is generated;
determining a denomination of the scrip;
determining a last access time of the web service by the client; and
evaluating a value of the scrip.

7. The method in claim 6, wherein determining the denomination of the scrip comprises determining the denomination based on factors selected from a group consisting of priority of the client requesting the web service and geographical location of the client.

8. The method in claim 6, wherein the value of the scrip comprises a value that is initially equal to the denomination of the scrip and is evaluated on every access to the web service.

9. The method in claim 1, wherein the client requesting access to the web service comprises the first server identifying the client by a unique client identifier (UCI).

10. A system, comprising:
a first server in a communication network hosting a web service;
a quantum determining unit to determine the quantum of the first server;
a scrip generator to generate the scrip for the first server; and
a property determining unit to determine properties of the scrip.

11. The system in claim 10, wherein the first server and a second server hosting the web service communicate via multicast internet protocol (IP).

12. The system in claim 10 further comprises a client accessing the web service hosted on the first server via a communication network.

13. The system in claim 12, wherein the client comprises a storage medium to store the scrip.

14. The system in claim 13, wherein the client further comprises an application programming interface (API) to update the scrip.

15. The system in claim 12, wherein the client accessing the web service comprises the first server identifying the client by a unique client identifier (UCI).

16. The system in claim 15, wherein the UCI comprises parameters selected from a group consisting of IP address and port number of the client.

17. An article of manufacture, comprising:
a machine readable medium having instructions that when executed by a machine cause the machine to execute a method, comprising:
generating a scrip dynamically for a first server hosting a web service in a communication network;
determining properties of the scrip dynamically; and
issuing the scrip to a client requesting access to the web service.

18. The article of manufacture in claim 17 further comprising:
throttling the web service by using the scrip; and
balancing a load between the first server and a second server hosting the web service by using the scrip.

19. The article of manufacture in claim 17, wherein generating a scrip dynamically comprises:
determining a quantum of the first server dynamically;
determining a total scrip value of the communication network comprising the first server and a second server hosting the web service as a function of total quanta of the communication network comprising the first server and the second server;
determining a scrip value of the first server based on the total scrip value of the communication network and quantum of the first server; and
splitting the scrip value into one or more denominations.

20. The article of manufacture in claim 19, wherein determining the quantum of the first server dynamically comprises determining the quantum based on factors selected from a group consisting of geographical location of the first server, number of clients requesting the web service, processing power of the first server and future projection of a number of requests.
